(19) United States
(12) Patent Application Publication
(10) Pub. No.: US 2004/0159984 A1
(43) Pub. Date: Aug. 19, 2004

(54) Sintered Y2O3 and the manufacturing method for the same

(75) Inventors: Keiichiro Isomura, Aichi (JP); Takayuki Ikeda, Aichi (JP); Yukitaka Murata, Aichi (JP)

Correspondence Address: FOLEY AND LARDNER, SUITE 500, 3000 K STREET NW, WASHINGTON, DC, 20007, US

(73) Assignee: TOSHIBA CERAMICS CO., LTD.

(21) Appl. No.: 10/778,172

(22) Filed: Feb. 17, 2004

(30) Foreign Application Priority Data
Feb. 17, 2003 (JP) 2003-037835
Feb. 17, 2003 (JP) 2003-037836

(51) Int. Cl. C04B 35/00; B28B 1/24

(52) U.S. Cl. 264/645; 501/126; 264/674; 264/328.2

(57) ABSTRACT

A method for casting Y₂O₃ has steps of adding an acid to a slurry comprising at least a ceramic material having a purity of an Y₂O₃ being 99 wt % or more with an average particle diameter of 2 μm or less, water, a binder and a dispersant so that a pH value can be adjusted ranging from 8.5 to 10.5 and injecting the slurry into a mold.

### BACKGROUND OF THE INVENTION

1. Field of the Invention

The present invention relates to a sintered Y₂O₃ and a manufacturing method for sintered Y₂O₃ that is a plasma-resistant member suitable for CVD or etching device.

2. Description of the Related Art

Due to its excellent resistance to plasma, molten salt, Uranium, Ti ally, etc., Y₂O₃ members are expected to be applied to semiconductor members, various melting crucibles, etc. Due to its excellent resistance to fluorine plasma in particular, Y₂O₃ members are much expected as members for semiconductor processing equipment.

Such a sintered Y₂O₃ is produced via molding, drying, degreasing and sintering steps. Since the Y₂O₃ material is extremely expensive, the molding step has required the application of near net-shaping technique, i.e., technique for producing a molded product having an external shape very close to that of the desired molded product. Examples of the technique for realizing this near net-shaping include injection molding and casting. Since molded Y₂O₃ products are required for large-sized products or products manufactured on a small-quantity many-types basis, casting is desired.

In a conventional, for casting of Y₂O₃, when Y₂O₃ and water were used to prepare a slurry, the Y₂O₃ material powder underwent vigorous agglomeration and thus could be difficultly slurried and could not be casted. Therefore, any method but dry press molding cannot accomplish the molding of Y₂O₃ material powder. Thus, near net-shaping technique can be difficultly applied to casting of Y₂O₃.

Although there are some examples of casting of Y₂O₃ material powder as a subsidiary material in the related art casting method (see Japanese Published Patent Application JP-A-5-77222), no methods for casting Y₂O₃ material powder as a main material have been ever realized.

Further, in the method for manufacturing the sintered Y₂O₃, the sintered Y₂O₃ has heretofore been produced by a so-called atmospheric sintering method involving sintering in the atmosphere. However, this atmospheric sintering is disadvantageous in that when molded Y₂O₃ is sintered while being directly exposed to the atmosphere, a sintered product colored yellow is produced. In order to produce a non-colored sintered product, it is necessary that the molded Y₂O₃ be encapsulated in a vessel made of a sintered product that doesn't contaminate the molded Y₂O₃ such as high purity alumina and sintered Y₂O₃ and be filled with Y₂O₃ filler. Accordingly, the dimension of the vessel of sintered product limits the sintering space, reducing the volumetric efficiency of the production facilities and giving inconvenience in mass production.

Further, in the atmospheric sintering of molded Y₂O₃, the sintering temperature is 1,700° C. at highest from the limitation of heat resistance of refractory suitable for the production of sintered Y₂O₃. Within this sintering temperature range, only a sintered Y₂O₃ having an average crystalline particle diameter of from 5 μm to 20 μm is obtained. Referring to color tone, the resulting sintered product assumes white color and has no transparent properties. Such a sintered Y₂O₃ product itself is excellent in plasma resistance but cannot meet requirements for further transparent properties as a member to be used for a window member in plasma processor.

Moreover, a technique has been known which comprises sintering molded Y₂O₃ in various atmospheres to produce sintered Y₂O₃ (see Japanese Published Patent Application JP-A-2002-68838). However, it is difficult to provide a dense sintered product by this technique and it cannot realize a sintered product having excellent transparent properties.

### SUMMARY OF THE INVENTION

An aim of the present invention is to realize desired casting of Y₂O₃ by forming a stable slurry without causing cohesion in the production of a molded product mainly composed of Y₂O₃ by a near net-shaping technique and obtain a dense sintered Y₂O₃. The manufacturing method of the present invention realizes a method for manufacturing a dense sintered Y₂O₃ using a simple procedure without any necessity of special sintering vessel or Y₂O₃ filler.

The inventors found that when an Y₂O₃ material is sintered at high temperature in a hydrogen atmosphere, the resulting a crystalline particle diameter of the sintered Y₂O₃ become larger and a dense sintered Y₂O₃ is obtained, hence can be provided with transparent properties without any necessity of special sintering vessel or Y₂O₃ filler. The invention has thus been worked out.

The invention concerns a method for casting Y₂O₃ has steps of adding an acid to a slurry comprising at least a ceramic material having a purity of an Y₂O₃ being 99 wt % or more with an average particle diameter of 2 μm or less, water, a binder and a dispersant so that a pH value can be adjusted ranging from 8.5 to 10.5 and injecting the slurry into a mold.

According to a second aspect of the present invention as set forth in the first aspect of the present invention, it is preferable that the pH value of the slurry adjusted by the addition of the acid in the casting of Y₂O₃ is ranging from 9.5 to 10.0.

According to a third aspect of the present invention as set forth in the first aspect of the present invention, it is preferable that the acid is an organic acid.

According to a fourth aspect of the present invention as set forth in the first aspect of the present invention, the dispersant is selected from at least one of sodium pyrophosphate, sodium hexametaphosphate and an organic surface-active agent of an anionic, a cationic and a nonionic.

According to a fifth aspect of the present invention as set forth in the first aspect of the present invention, it is preferable that a concentration of the dispersant is ranging from 0.1 to 1.0 wt % based on a weight of the material.

According to a sixth aspect of the present invention as set forth in the first aspect of the present invention, it is preferable that a concentration of the binder is ranging from 0.5 to 4.0 wt % based on the material.

According to a seventh aspect of the present invention as set forth in the first aspect of the present invention the acid for adjusting the pH value is selected at least one of acetic acid, formic acid, lactic acid, oxalic acid and citric acid.

According to an eighth aspect of the present invention as set forth in the first aspect of the present invention, it is preferable that a concentration of the acid: for adjusting the pH value is ranging from 1.0 to 10 mol/l.

According to a ninth aspect of the present invention as set forth in the first aspect of the present invention, it is preferable that when a concentration of the slurry is defined as Mm/(Mm+Mw), wherein Mm represents mass of the material and Mw represents mass of water, the concentration of the slurry is ranging from 50 to 80 wt %.

According to a tenth aspect of the present invention, a sintered Y₂O₃ obtained by sintering a molded product of Y₂O₃ material having a purity of 99 wt % or more with an average particle diameter of 2 μm or less at a temperature ranging from 1,710° C. to 1,850° C. in a hydrogen atmosphere so that an Y₂O₃ crystal having an average crystalline particle is formed in a diameter ranging from 10 to 800 μm in the sintered Y₂O₃.

According to an eleventh aspect of the present invention as set forth in the tenth aspect of the present invention, it is preferable that the average crystalline particle diameter of the sintered Y₂O₃ is ranging from 50 to 500 μm. By obtaining such the sintered Y₂O₃, it becomes able to realize the sintered Y₂O₃ having transparent property, which was difficult to realize heretofore.

According to a twelfth aspect of the present invention as set forth in the eleventh aspect of the present invention, it is preferable that the sintered Y₂O₃ has a transparent property.

According to a thirteen aspect of the present invention, a manufacturing method for a sintered Y₂O₃ has steps of molding a Y₂O₃ material having a purity of 99 wt % or more with an average particle diameter of 2 μm or less to obtain a molded product and sintering the obtained molded product at a temperature ranging from 1,710° C. to 1,850° C. in a hydrogen atmosphere so that an Y₂O₃ crystal having an average crystalline particle is formed in a diameter ranging from 10 to 800 μm. Owing to the manufacturing method of the present invention, it is realized the sintered Y₂O₃ having Y₂O₃ crystal having transparent property and high density.

According to an fourteenth aspect of the present invention, a sintered Y₂O₃ obtained by process of adding an acid to a slurry comprising at least a ceramic material having a purity of an Y₂O₃ being 99 wt % or more with an average particle diameter of 2 μm or less, water, a binder and a dispersant so that a pH value can be adjusted ranging from 8.5 to 10.5 injecting the slurry into a mold to obtain a molded product and sintering the obtained molded product at a temperature ranging from 1,710° C. to 11, 850° C. in a hydrogen atmosphere so that an Y₂O₃ crystal having an average crystalline particle is formed in a diameter ranging from 10 to 800 μm.

According to a fifteenth aspect of the present invention as set forth in the fourteenth aspect of the present invention, it is preferable the average crystalline particle diameter of the sintered Y₂O₃ is ranging from 50 to 500 μm.

According to a sixteenth aspect of the present invention as set forth in the fifteenth aspect of the present invention, it is preferable that the sintered Y₂O₃ has a transparent property.

According to a seventeenth aspect of the present invention, a manufacturing method for a sintered Y₂O₃ has steps of adding an acid to a slurry comprising at least a ceramic material having a purity of an Y₂O₃ being 99 wt % or more with an average particle diameter of 2 μm or less, water, a binder and a dispersant so that a pH value can be adjusted ranging from 8.5 to 10.5, injecting the slurry into a mold to obtain a molded product and sintering the obtained molded product at a temperature ranging from 1,710° C. to 1,850° C. in a hydrogen atmosphere so that an Y₂O₃ crystal having an average crystalline particle is formed in a diameter ranging from 10 to 800 μm. In the before said present invention, the molding step for Y₂O₃ material is casting method. Owing to this method, sintered Y₂O₃ having high density can be obtained.

According to an eighteenth aspect of the present invention as set forth in the seventeenth aspect of the invention, it is preferable that wherein the pH value of the slurry adjusted by the addition of the acid in the casting of Y₂O₃ is ranging from 9.5 to 10.0.

According to a nineteenth aspect of the present invention as set forth in the seventeenth aspect of the invention, it is preferable that the acid is an organic acid.

### DETAILED DESCRIPTION OF THE PREFERRED EMBODIMENTS

The principle of the invention will be described hereinafter. When Y₂O₃ and water are used for preparing slurry, the resulting a pH value of the slurry exhibits more than 11 due to the elution of Y³⁺ and thus can not be prevented from cohesion even with the addition of a dispersant. This slurry cannot even have a binder incorporated therein. The inventors studied the control over pH of slurry by the addition of an acid. As a result, it was confirmed that an Y₂O₃ material powder could be casted within an optimum pH range without cohesion. The invention has thus been worked out.

Also, the inventors found that when an Y₂O₃ material is sintered at high-temperature rather than in the atmosphere, the resulting the crystalline particle diameter of the Y₂O₃ becomes larger and hence can be provided with transparent properties without any necessity of special sintering vessel or Y₂O₃ filler. The invention has thus been worked out.

In other words, an acid is added at a step of dispersing a Y₂O₃ material powder having a purity of 0.99 wt % or more with an average particle diameter of 2 μm or less in water to prepare a slurry so that the resulting slurry has an optimum pH value and hence a good stability and pouring this in a mold, and sintering this molded product at a temperature of from 1,710° C. to 1,850° C. in a hydrogen atmosphere so that a Y₂O₃ crystal having an average crystalline particle diameter of from 10 to 800 μm is formed. This sintered material has a high purity, a high denseness and a high bending strength and thus is excellent as a member for semiconductor processing member, particularly device for plasma treatment.

The sintered Y₂O₃ having an average crystalline particle diameter of from 50 to 500 μm has a higher denseness and better transparent properties. Accordingly, such a material have a good transparent property while such the material having plasma-resistant that heretofore was difficult to realize in the aforementioned plasma processing equipment and thus can be used as a window material for plasma processor.

The invention will be further described in the following various steps.

(Step of Preparing Slurry)

The first step is a step of preparing a slurry from an Y₂O₃ material. The preparation of the slurry can be accomplished by adding a Y₂O₃ material, a dispersant and a binder to water, adding an acid to the mixture to adjust the pH value thereof, and then stirring the mixture.

The order of addition, pH adjustment and stirring of the material powder, dispersant, binder and water at this step is not specifically limited. However, from the standpoint of workability, a process is desirable the order of adding a dispersant to water, adding a Y₂O₃ material powder to the mixture with stirring, adding a binder to the mixture, adding an acid to the mixture to adjust the pH value thereof, and then stirring the mixture. However, the addition of the dispersant and the binder to water may be followed by the addition of the Y₂O₃ material powder and adjusting the pH value thereof.

The stirring of the slurry can be accomplished by the use of a stirring mixer. The stirring is preferably affected to an extent such that the secondary particles constituting the material powder are dissociated to make a uniform dispersion. To this end, the stirring is preferably affected for from 1 to 10 hours.

As the Y₂O₃ material there may be used one having a purity of 99 wt % or more. In order to use the casted Y₂O₃ for semiconductor processing equipment, it is necessary that the Y₂O₃ material to be used have a high purity to prevent the semiconductor wafer to be processed from being contaminated by impurities. An Y₂O₃ material having a purity of 0.99% or more can provide a material fully suitable for this purpose. When the purity of Y₂O₃ falls below 99%, it is disadvantageous in that when a member made of this material is used for semiconductor device; impurities can be attached to the surface of the semiconductor wafer as foreign matters or the semiconductor wafer can be contaminated by impurities such as metal.

As the Y₂O₃ material powder there should be used one having an average particle diameter of 2 μm or less. When a Y₂O₃ material having an average particle diameter of greater than 2 μm is used, the resulting slurry undergoes precipitation of Y₂O₃ material powder in a short period of time and thus can difficultly be casted and owing to a decreasing of a density of the molded product, a density of the sintered product decreases, a bending strength of the sintered Y₂O₃ becomes less than 50 MPa. An excessively atomized starting material powder can be difficultly handled but can advantageously provide a sintered product having an enhanced density.

On the contrary, a slurry prepared from an Y₂O₃ material having an average particle diameter of 2 μm or less undergoes no precipitation of particles even after 1 day of standing and thus can be casted without troubles. The smaller the average particle diameter of the Y₂O₃ material powder is, the more difficultly can be dispersed the Y₂O₃ material powder in water and the more time takes it to prepare a desired slurry. However, such the slurry can be casted without any troubles.

As the dispersant to be used at this step there may be used one having a surface activating effect commonly used in the preparation of slurry. As the dispersant having a surface activating effect there may be used a phosphate such as sodium pyrophosphate and sodium hexametaphosphate or an organic surface-active agent of an anionic, cationic or nonionic.

The amount of such a dispersant to be incorporated is preferably from 0.1 to 1 wt % based on the weight of the material powder.

As the binder there may be used a known binder for use in the production of molded ceramics such as acryl polymer and PVA. The amount of the binder to be used is preferably from 0.5 to 4 wt % based on the amount of the material powder. When the amount of the binder to be used falls below the above-defined range, the molded product obtained by casting exhibits a low strength and thus can be easily damaged during handling. On the contrary, when the amount of the binder to be used exceeds the above-defined range, when degreased and sintered, the ratio of porous becomes greater and it is difficult to obtain a dense sintered product.

As the acid to be used in pH adjustment, in the invention, there may be used an aqueous solution of an inorganic acid such as hydrochloric acid, sulfuric acid, nitric acid and phosphoric acid or an organic acid such as acetic acid, formic acid, lactic acid, oxalic acid and citric acid. Among these acids, the inorganic acid is evaporated in the heating furnace from the molded product obtained by casting when it is degreased and sintered, possibly causing the corrosion of the members in the furnace. Thus, using the organic acid is preferable. The more dilute these acids are, the more easily can be effected pH adjustment. However, the use of a dilute acid means the addition of a large amount of water content that makes it difficult to adjust the concentration of the slurry. The optimum concentration range is preferably from about 1 to 10 mol/l.

When defining the concentration of the slurry as Mm/(Mm+Mw), wherein Mm represents mass of the material and Mw represents mass of water, the concentration of the slurry is preferably as high as possible to raise the density of the resulting molded product so far as the slurry is fluid but may be changed depending on the desired denseness of the sintered Y₂O₃. The concentration of the slurry is preferably from 50 to 80 wt %.

While the aforementioned description has been made with reference to the case where as the components constituting the slurry there are used a material powder, a dispersant and a binder, further additives used in ordinary casting process such as anti-foaming agent for eliminating bubbles generated in the slurry may be used.

(Casting Step)

The casting step of the second step will be further described hereinafter.

The casting is also called slip casting. In some detail, the slurry is injected into a mold, removed water content from the mold and dried to form a molded product. As the casting mold to be used in the present invention there may be used a casting mold used in ordinary casting process such as water-absorbing mold made of gypsum, resin mold and ceramic mold.

Referring to casting method, a method may be employed which comprises injecting a slurry having a high solid content and hence a low fluidity into the mold under pressure besides the typical casting method involving the injection of a slurry having a high fluidity into the mold.

Thus, the employment of the casting method of the invention makes it easy to form a molded product having a complicated shape by an Y₂O₃ material.

The third step involves degreasing and sintering. In the case where no organic additives have been added so far, degreasing may be omitted. However, in the case where an organic material such as binder has been added, the molded product is heated to decompose or evaporate the organic material away. The heating temperature may be from 500° C. to 900° C.

Subsequently, the molded product of Y₂O₃ powder is sintered in a hydrogen atmosphere.

The hydrogen atmosphere to be used at this step may be pure hydrogen but may comprise an inert gas non-reactive with Y₂O₃ such as argon gas incorporated therein. However, a commercially available hydrogen gas free of argon gas is most desirable taking into account economy. The hydrogen atmosphere gas may be allowed to run through or reside in the sintering furnace.

In the present invention, a hydrogen gas is used as an atmosphere gas, making it possible to prevent the material to be sintered from being colored even when heated without being covered by a filler or fixture and hence provide a transparent sintered product. Further, the material is heated in a hydrogen atmosphere, making it possible to reduce the amount of metallic impurities present on the surface of the molded product and hence provide a material suitable for semiconductor processing equipment. Moreover, as a material for sintering furnace there may be used molybdenum table or tungsten heater, making it possible to sinter the Y₂O₃ material at a temperature as high as 1,700° C. or more without having any restriction on heating temperature of material in the sintering furnace and hence enhance the denseness of the sintered product.

As previously mentioned, the sintering temperature at the present step is preferably from 1,710° C. to 1,850° C. When the sintering temperature is 1,700° C. or, less, the resulting sintered product insufficiently exhibits a bending strength of the sintered Y₂O₃ less than 50 MPa. On the contrary, in order to sinter the material at a temperature of higher than 1,850° C., it is necessary that the member of the sintering furnace have better heat resistance. However, the resulting-sintered Y₂O₃ cannot be expected to have improvements in properties that pay for the employment of such a heat-resistant member. Thus, this temperature range higher than 1,850° C. is not economical.

The aforementioned sintering temperature may be arbitrarily predetermined between 1,710° C. and 1,850° C. When the sintering temperature is between 1,710° C. and 1,780° C., the resulting sintered Y₂O₃ has an average crystalline particle diameter of less than 30 μm and thus exhibits insufficient transparent properties. When the sintering temperature exceeds 1,780° C., the resulting sintered Y₂O₃ has an average crystalline particle diameter of 30 μm or more and thus exhibits transparent properties. Thus, the higher the sintering temperature is, the greater is the average crystalline particle diameter of the resulting sintered Y₂O₃ and the better are the transparent properties of the sintered Y₂O₃. However, as the sintering temperature rises, the mechanical strength of the sintered product decreases. In order that the resulting member for semiconductor can attain a necessary bending strength of 50 MPa or more, it is required that the average crystalline particle diameter of the resulting sintered Y₂O₃ be 400 μm or less and the sintering temperature be at 1,850° C. or less.

Accordingly, the sintering temperature of Y₂O₃ is preferably from 1,780° C. to 1,850° C. for obtaining the sintered Y₂O₃ having high density, necessity bending strength and further transparent property. When using the sintered Y₂O₃ for a semiconductor processing equipment, it is not a problem that the density of the sintered product is greater than 4.98 g/cm³, it is more preferably that the density of the sintered product is greater than 4.99 g/cm³.

In this embodiment, a casting method was adopted as a molding method of the second step, however, a designable shape can be obtained by a dry molding method.

Referring to the dry molding method, as a drying pressure molding method there may be used monoaxial pressure molding or hydrostatic pressure molding method, which has heretofore been known.

The dry molding can be carried out in the following manner. To an Y₂O₃ powder that is a staring material are added a binder such as PVA and purified water. The mixture is then stirred using a known mixer. The obtained slurry is then dried by a spray dryer so that it is granulated. The particulate mixture thus obtained is packed in a mold, and then subjected to pressure molding using a monoaxial molding machine or Cold Isostatic. Pressing (CIP). The amount of the binder to be added during this procedure is preferably from 0.5 to 3 wt % though depending on the particle diameter of the particulate material. Further, the size of the particles obtained by granulation using the spray dryer is preferably from about 10 to 200 μm.

In the aforementioned method, when the particle diameter of the particulate material is close to 1 μm, the particulate material may not be granulated before being mixed with the binder and subjected to pressure molding.

Referring to the wet molding method, extrusion, wet pressure molding, casting and other methods that have been heretofore known may be employed. Preferred among these wet molding methods is casting because it can provide a near-net-shape product that eliminates the necessity of subsequent step such as cutting step, making it possible to simplify the production step and form a dense molded product having a complicated shape.

The casting can be accomplished in the following manner. To an Y₂O₃ powder which is a starting material are added additives such as dispersant, plasticizer and gelatinizing agent and water. The mixture is then stirred. The slurry thus obtained is poured into a mold such as gypsum mold, resin mold and ceramic mold optionally under pressure, and then dried in the mold so that it is molded.

### TEST SAMPLE EXAMPLES

### Sample 1-4; Comparative Example 1

As a dispersant there was used a polyacrylic acid. The polyacrylic acid was then added to pure water in a proportion of 0.5 wt % based on the weight of the starting material. To the aqueous solution thus prepared was then added a Y₂O₃ material powder (purity: 99% or more) having an average particle diameter set forth in Table 1 in a concentration of 70 wt % based on the weight of the slurry. To the slurry thus obtained was then added acetic acid to adjust the pH value thereof to 9.8. The slurry was charged in a ball mill where it was then stirred for 24 hours to obtain the slurry having a viscosity of 40 cps. Another slurry was prepared in the same manner as in Sample 3 except that no acid was added (Comparative Example 1).

TABLE 1

| | Average particle | | |
|---|---|---|---|
| | diameter of starting | | |
| Sample No. | material powder | Acid added | State of slurry |
| Comparative | 1.5 μm | No | Starting |
| Example 1 | | | material powder |
| | | | cohesion |
| Sample 1 | 0.3 μm | Acetic | Stable |
| | | acid | |
| Sample 2 | 0.8 μm | Acetic | Stable |
| | | acid | |
| Sample 3 | 1.5 μm | Acetic | Stable |
| | | acid | |
| Sample 4 | 2.0 μm | Acetic | Stable |
| | | acid | |
| Comparative | 2.5 μm | Acetic | Starting |
| Example 2 | | acid | material powder |
| | | | precipitated |

The slurry thus obtained was then injected into a gypsum mold and an epoxy resin mold to obtain a molded product having a size of 100 mm×100 mm×10 mm. The same slurry was subjected to “SHINTO-V process” to obtain a molded product having a size of 100 mm×100 mm×10 mm.

These molded products were each dried, degreased, and then sintered at 1,700° C. in the atmosphere. In all these cases, a sintered product having a density of 99% or more of the theoretical density of Y₂O₃ can be obtained.

As can be seen in the results set forth in Table 1, the slurries the pH value of which had not been adjusted underwent cohesion of material powder and thus could not been used in casting. Referring to the starting material powder to be used, those having an average particle diameter of up to 2.0 μm could provide a slurry that is stable and suitable for casting.

### Samples 4-7; Comparative Examples 3, 4

In order to determine the optimum pH value of slurry, the following experiments were conducted.

As a dispersant there was used a polyacrylic acid. The polyacrylic acid was added to Y₂O₃ material having an average particle diameter of 0.3 μm and a purity of 99% in a concentration of 70 wt % based on the weight of the slurry. To the mixture was then added an aqueous solution of hydrochloric acid to provide mixtures having various pH values. These mixtures were each then stirred in a ball mill for 24 hours to prepare slurries. The slurries thus obtained were each observed for state. The results are set forth in Table 2.

TABLE 2

| Sample No. | pH | State of slurry |
|---|---|---|
| Comparative Example 3 | 8.0 | Cohesion |
| Sample 4 | 8.5 | Stable |
| Sample 5 | 9.5 | Stable |
| Sample 6 | 10.5 | Stable |
| Sample 7 | 10.5 | Stable |
| Comparative Example 4 | 11.0 | Cohesion |

As can be seen in the results as set forth in Table 2, the slurries having a pH value of less than 8.5 or 10.6 or more underwent cohesion of staring material powder. On the contrary, the slurries having a final pH value of from 8.5 to 10.5 could avoid the cohesion of starting material powder. The slurries having a pH value of from 9.5 to 10.0 stayed more stable.

### Samples 8 to 10; Comparative Example 5

In order to determine the optimum concentration of slurry, the following experiments were conducted. In some detail, slurries were prepared in the same manner as in Sample 1 except that the water content was adjusted such that the concentration of slurry was as set forth in Table 3.

TABLE 3

| | Concentration of | |
|---|---|---|
| Sample No. | slurry (wt %) | State of slurry |
| Sample 8 | 50 | Stable |
| Sample 9 | 60 | Stable |
| Sample 10 | 70 | Stable |
| Sample 11 | 80 | Stable |
| Comparative Example 5 | 85 | Cohesion |

As can be seen in the results as set forth in Table 3, the slurries having a concentration of up to 80 wt % stayed stable and thus could be used in casting.

### Samples 12 to 16; Comparative Example 6

Polyacrylic acid was used as a dispersant, and added 0.5 wt % based on the material, 2 parts by weight of PVA were added to 100 parts by weight of a Y₂O₃ powder having an average particle diameter of 1 μm and a purity of 99.9% as a binder, added water to adjust the concentration of the slurry to be 70 wt % prepared the slurry by adding a acetic acid to adjust the pH value thereof to be 10.0. The mixture was then stirred in a wet process to form slurry. The slurry thus formed was poured into a gypsum mold where it was then dried to form a tablet having a size of 200 mm×200 mm×10 mm. The molded product was heated to 900° C. so that it was degreased, and then sintered in a H₂ atmosphere flowing at a rate of 1 m³/hr at 1,700° C., 1,720° C., 1,750° C., 1,780° C., 1,800° C. and 1,850° C. for 6 hours to form a sintered product. The six molded products thus obtained were each then evaluated for average crystalline particle diameter, bending strength, transparent properties and density. For the evaluation of the presence of transparent properties, a sample having a thickness of 10 mm was examined for transparent property. Those having a visible transparency of higher than 10% were judged to have transparent properties.

The results are as set forth in Table 4.

TABLE 4

| | | | Average | | | |
|---|---|---|---|---|---|---|
| | Sintering | | crystalline | Bending | Provided with | |
| | temperature | Sintering | particle | strength | transparent | Density |
| Sample No. | (° C.) | atmosphere | diameter (μm) | (MPa) | properties? | (g/cm³) |
| Comparative | 1,700 | Atmosphere | 5 | 145 | No | <4.98 |
| Example 6 | | | | | | |
| Sample 12 | 1,720 | Hydrogen | 10 | 135 | No | ≧4.99 |
| Sample 13 | 1,750 | Hydrogen | 24 | 127 | No | ≧4.99 |
| Sample 14 | 1,780 | Hydrogen | 34 | 98 | Yes | ≧4.99 |
| Sample 15 | 1,800 | Hydrogen | 87 | 76 | Yes | ≧4.99 |
| Sample 16 | 1,850 | Hydrogen | 400 | 50 | Yes | ≧4.99 |

As can be seen in the results of Table 4, the sintered product obtained by the sintering at about 1,700° C. in the atmosphere, which has heretofore been normally practiced, had a density considerably lower than the theoretical density of Y₂O₃, which is 5.02. On the other hand, the sintered products of the invention had a density of 4.99 or more, which is considerably close to the theoretical density of Y₂O₃.

### Samples 17, 18

In order to compare the properties of sintered products obtained by different molding methods, the results of hydrogen sintering of molded products prepared by pressure casting using a resin mold (Sample 17) and CIP molding (Sample 18) will be exemplified below. In the method of Sample 17, which is a pressure casting using a resin mold, a slurry was prepared in the same manner as in Sample 12. The slurry thus prepared was packed in a mold made of a synthetic resin where it was then compressed at a pressure of 1 kgf/cm² to form a tablet having a size of 200 mm×200 mm×10 mm. The tablet thus formed was dried, degreased in the same manner as in Sample 12, and then sintered at 1,780° C. In the method of Sample 18, which is CIP molding, a granular material prepared by a spray dryer was subjected to Cold Isostatic pressing (CIP) at a pressure of 100 MPa to form a tablet having a size of 200 mm×200 mm×10 mm. The tablet thus formed was degreased in the same manner as in Sample 12, and then sintered in a hydrogen atmosphere at 1,780° C. for 6 hours.

These samples were each then measured for density. As a result, the sample of Sample 17 prepared by casting had a density of 4.99 g/cm³ or more and exhibited transparent properties while the sample of Sample 18 prepared by CIP molding had a density of 4.98 g/cm³ and exhibited no transparent properties.

While there has been described in connection with the preferred embodiments of the present invention, it will be obvious to those skilled in the art that various changes and modification maybe made therein without departing from the present invention, and it is aimed, therefore, to cover in the appended claim all such changes and modifications as fall within the true spirit and scope of the present invention.

In accordance with the present invention, a stable Y₂O₃ slurry can be prepared without causing cohesion, making it possible to realize a casted product suitable for near net-shaping as a Y₂O₃ material.

The sintered Y₂O₃ according to the present invention is dense and has transparent properties and can realize a sintered product that can be used as a member of semiconductor processing equipment such as window material for plasma processing equipment.

Further, the process for the production of a sintered Y₂O₃ according to the present invention allows the production of a dense and transparent sintered Y₂O₃ using a simple device and procedure.

What is claimed is:

1. A method for casting Y₂O₃ comprising steps of:
adding an acid to a slurry comprising at least a ceramic material having a purity of an Y₂O₃ being 99 wt % or more with an average particle diameter of 2 μm or less, water, a binder and a dispersant so that a pH value can be adjusted ranging from 8.5 to 10.5; and
injecting the slurry into a mold.

2. A method for casting Y₂O₃ as set forth in claim 1, wherein the pH value of the slurry adjusted by the addition of the acid in the casting of Y₂O₃ is ranging from 9.5 to 10.0.

3. A method for casting Y₂O₃ as set forth in claim 1, wherein the acid is an organic acid.

4. A method for casting Y₂O₃ as set forth in claim 1, wherein the dispersant is selected from at least one of sodium pyrophosphate, sodium hexametaphosphate and an organic surface-active agent of an anionic, a cationic and a nonionic.

5. A method for casting Y₂O₃ as set forth in claim 1, wherein a concentration of the dispersant is ranging from 0.1 to 1.0 wt % based on a weight of the material.

6. A method for casting Y₂O₃ as set forth in claim 1, wherein a concentration of the binder is ranging from 0.5 to 4.0 wt % based on the material.

7. A method for casting Y₂O₃ as set forth in claim 1, wherein the acid for adjusting the pH value is selected at least one of acetic acid, formic acid, lactic acid, oxalic acid and citric acid.

8. A method for casting Y₂O₃ as set forth in claim 1, wherein a concentration of the acid for adjusting the pH value is ranging from 1.0 to 10 mol/l.

9. A method for casting Y₂O₃ as set forth in claim 11, wherein when a concentration of the slurry is defined as
Mm/(Mm+Mw),
wherein Mm represents mass of the material and Mw represents mass of water, the concentration of the slurry is ranging from 50 to 80 wt %.

10. A sintered Y₂O₃ obtained by sintering a molded product of Y₂O₃ material having a purity of 99 wt % or more with an average particle diameter of 2 μm or less at a temperature ranging from 1,710° C. to 1,850° C. in a hydrogen atmosphere so that an Y₂O₃ crystal having an average crystalline particle is formed in a diameter ranging from 10 to 800 μm in the sintered Y₂O₃.

11. A sintered Y₂O₃ as set forth in claim 10, wherein the average crystalline particle diameter of the sintered Y₂O₃ is ranging from 50 to 500 μm.

12. A sintered Y₂O₃ as set forth in claim 11, wherein the sintered Y₂O₃ has a transparent property.

13. A manufacturing method for a sintered Y₂O₃ comprising steps of:
molding a Y₂O₃ material having a purity of 99 wt % or more with an average particle diameter of 2 μm or less to obtain a molded product; and
sintering the obtained molded product at a temperature ranging from 1,710° C. to 1,850° C. in a hydrogen atmosphere so that an Y₂O₃ crystal having an average crystalline particle is formed in a diameter ranging from 10 to 800 μm.

14. A sintered Y₂O₃ obtained by process of:
adding an acid to a slurry comprising at least a ceramic material having a purity of an Y₂O₃ being 99 wt % or more with an average particle diameter of 2 μm or less, water, a binder and a dispersant so that a pH value can be adjusted ranging from 8.5 to 10.5;
injecting the slurry into a mold to obtain a molded product; and
sintering the obtained molded product at a temperature ranging from 1,710° C. tol, 850° C. in a hydrogen atmosphere so that an Y₂O₃ crystal having an average crystalline particle is formed in a diameter ranging from 10 to 800 μm.

15. A sintered Y₂O₃ as set forth in claim 14, wherein the average crystalline particle diameter of the sintered Y₂O₃ is ranging from. 50 to 500 μm.

16. A sintered Y₂O₃ as set forth in claim 15, wherein the sintered Y₂O₃ has a transparent property.

17. A manufacturing method for a sintered Y₂O₃ comprising steps of:
adding an acid to a slurry comprising at least a ceramic material having a purity of an Y₂O₃ being 99 wt % or more with an average particle diameter of 2 μm or less, water, a binder and a dispersant so that a pH value can be adjusted ranging from 8.5 to 10.5;
injecting the slurry into a mold to obtain a molded product; and
sintering the obtained molded product at a temperature ranging from 1,710° C. to 1,850° C. in a hydrogen atmosphere so that an Y₂O₃ crystal having an average crystalline particle is formed in a diameter ranging from 10 to 800 μm.

18. A manufacturing method for sintered Y₂O₃ as set forth in claim 17, wherein the pH value of the slurry adjusted by the addition of the acid in the casting of Y₂O₃ is ranging from 9.5 to 10.0.

19. A manufacturing method for sintered Y₂O₃ as set forth in claim 17, wherein the acid is an organic acid.
